(19) United States
(12) Patent Application Publication
(10) Pub. No.: US 2005/0115083 A1
(43) Pub. Date: Jun. 2, 2005

(54) Knife with an ergonomic handle

(75) Inventor: Erik T. Lauridsen, Vejle (DK)

Correspondence Address: FOLEY & LARDNER, 777 EAST WISCONSIN AVENUE, SUITE 3800, MILWAUKEE, WI, 53202-5308, US

(73) Assignee: Fiskars Danmark A/S

(21) Appl. No.: 10/976,013

(22) Filed: Oct. 28, 2004

(30) Foreign Application Priority Data
Oct. 28, 2003 (DK) PA 2003 01585

(51) Int. Cl. B26B 3/00

(52) U.S. Cl. 30/340

(57) ABSTRACT

A knife has an elongated knife blade extending along an axis and a handle extending along a second axis, the two axes being substantially parallel or having slightly deviating directions. The handle has an end face extending between upper and lower end points along a side face of the knife blade, the lower end point being positioned on a protrusion of the handle in front of the grip portion. The protrusion has a rear face extending rearwards under an acute angle relative to the second axis, and a line through the end points of the end face in a downward direction extends backwards under a second acute angle relative to the second axis.

### CROSS-REFERENCE TO RELATED APPLICATIONS

The present application claims the benefit of priority from Danish Patent Application No. PA 2003 01585 filed on Oct. 28, 2003, which is incorporated herein by reference in its entirety.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND OF THE INVENTION

The present invention relates to a knife with an ergonomic handle having a grip portion, said knife having an elongate, substantially planar knife blade with two side faces, a longitudinal lower cutting edge and an opposite, longitudinal upper back extending from a free front end of the knife blade to the handle, the knife blade having an axis extending from a central point between the cutting edge and the back at the free front end, e.g. a point, to a central point between the cutting edge and the back at the handle, the handle extending along a second axis defined by central points of cross sections at intended resting points for the forefinger and the little finger of a user on the grip portion of the handle, whereby the two axes are substantially parallel or have slightly deviating directions, preferably with a deviation of less than 20°, preferably less than 10°, the handle having an end face extending between upper and lower end points along a side face of the knife blade at the end opposite its free end, the lower end point being positioned on a protrusion of the handle in front of the grip portion, the protrusion having a rear face.

A knife of this type is commonly used, for instance in every kitchen, where it is used for many different cutting, carving and chopping operations in connection with the preparation of food.

An example of a handle for a knife of the above-mentioned type is known from German Design Registration No. M9608117.1, in which the rear face of the protrusion at the free end of the protrusion in a direction away from the grip portion extends downwards under a substantially right angle relative to the second axis, and a line through the end points of the end face in a downward direction extends rearwards under an angle of approximately 58° relative to the second axis.

U.S. Pat. No. 1,754,543 discloses a butcher's knife with a protrusion at the end of the handle at the knife blade, the rear face of said protrusion extending rearwards under an angle of approximately 79° relative to the longitudinal axis of the handle, while a line through the end points of the end face forms an angle of approximately 83° with the longitudinal axis of the handle.

The invention relates in particular, but not exclusively, to a kitchen knife.

During the various operations mentioned above, the knife is held with various grips or hand positions, several of which involve a grip around the grip portion of the handle, but it may, for instance in connection with a chopping operation, be more convenient to move the hand towards the knife blade in order to be able to press the knife downwards against the stuff to be chopped from a position more vertically above the cutting edge. Thereby the hand is moved forwards onto the back of the knife blade, which does not, from an ergonomic point of view, provide a particularly suitable grip.

### BRIEF SUMMARY OF THE INVENTION

One object of the invention is to provide a knife with a handle, which makes several ergonomically good grips or hand positions possible.

The object recited above is met by a knife, which is characterized in that the rear face of the protrusion at the free end of the protrusion in a direction away from the grip portion extends rearwards (i.e. the rear face has a tangent extending rearwards away from the handle) under an acute angle relative to the second axis, said angle being smaller than 80°, preferably smaller than 70°, that a line through the end points of the end face in a downward direction extends rearwards under a second acute angle relative to the second axis, said second acute angle being smaller than 50°. It should be noted that said angles lie in a plane parallel with the knife blade.

Due to the relatively small second angle the handle is made to extend far in front of the grip portion without enlarging the entire handle, understood as the distance from the rear end of the handle to the rear end of the cutting edge of the knife blade. This extension in front of the grip portion provides for a rest for a user's forefinger, when this is extended in front of the hand in a grip used when precise cuts are intended with the knife; this grip is referred to as a “precision grip.”

Further, with the relatively small second angle it is attained that a user at a grip around the handle, in which the hand has been moved forwards from the grip portion, conveniently may let his forefinger extend along the end face of the handle and the side face of the knife blade, the palm of the hand resting simultaneously on the upper side of the handle and the 3rd-5th fingers gripping around the grip portion. This grip is convenient for chopping e.g. onions and is referred to as a “chopping grip.”

The end face preferably extends concavely between its end points, preferably with a radius of curvature of less than 20 cm, preferably less than 10 cm, and particularly preferred said radius of curvature is 6-7 cm. This provides a particularly comfortable grip.

The distance between the end points is preferably at least 45 mm, preferably at least 50 mm. This gives this part of the handle a size, which ensures a good grip.

The end face is preferably beveled and forms an obtuse angle with the side face of the knife blade, said obtuse angle being preferably smaller than 140°, preferably smaller than 130°, and said obtuse angle being preferably bigger than 105°, preferably bigger than 120°. This contributes to providing a comfortable rest for the forefinger.

The handle protrudes a distance over the cutting edge and has preferably above the cutting edge an upwards facing, concave pressure face for a finger rest. This contributes not only to making said forwardly moved grip comfortable, but also to providing a good grip in cases where the grip portion itself is gripped by the hand, while a single finger or thumb is stretched forward over the knife.

### BRIEF DESCRIPTION OF THE SEVERAL VIEWS OF THE DRAWING

Examples of the invention will now be explained below with reference to the schematic drawings, in which

FIG. 1 shows a knife according to the invention seen from the side,

FIG. 2 is an enlarged view of the handle of the knife in FIG. 1,

FIG. 3 is a sectional view at line III-III in FIG. 2,

FIG. 4 shows the handle in FIG. 2 seen from above,

FIGS. 5-7 show various grips around the grip portion of the knife handle,

FIG. 8 shows a grip on the knife, the hand being advanced on the grip portion,

FIGS. 9 and 10 show knives with the same handle as the knife shown in FIGS. 1-8 but with different knife blades.

### DETAILED DESCRIPTION OF THE INVENTION

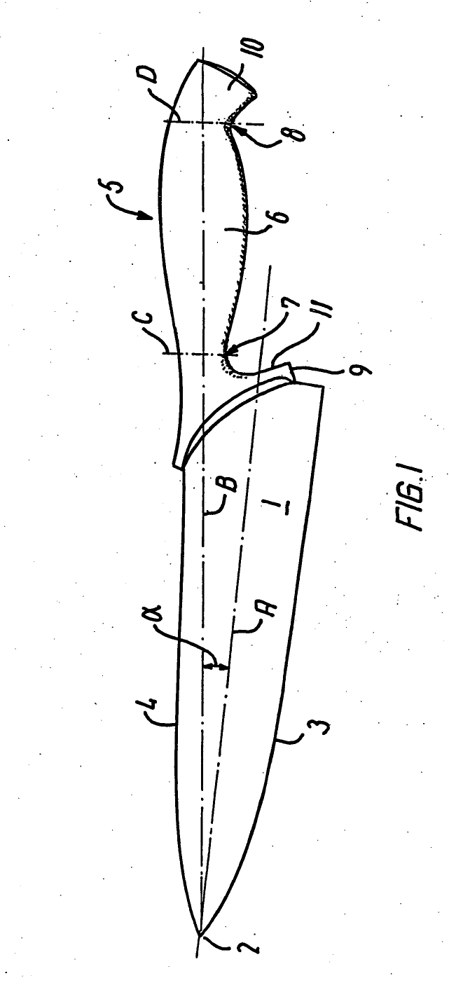

The knife shown in the figures has an elongate knife blade 1, for which an axis A may be defined by a point 2 at the free end of the knife blade and a central point between a sharp cutting edge 3, facing downwards in FIG. 1, and an upwards facing back 4. The cutting edge extends at its end closest to a handle 5 of the knife substantially parallel with the axis A, but it should be understood, however, that the cutting edge 3 is curved as is usual for a kitchen knife.

The handle 5 has a bulging grip portion 6, which is defined by places for the intended positioning of the forefinger and the little finger, respectively, of a user. These two places are marked by indentations 7 and 8 in the bottom side of the handle 5, as seen in FIG. 1, said indentations 7 and 8 being defined by a protrusion 9 near the knife blade 1 and an enlargement 10 of the handle 5 at its free end, respectively, together with the bulging of the grip portion 6.

In respect of the handle 5 an axis B is defined by central points of cross sections C and D at the bottom of the indentations 7 and 8, respectively.

The axis A and the axis B may be parallel, or they may extend under a mutual angle α, which is usually smaller than 10°.

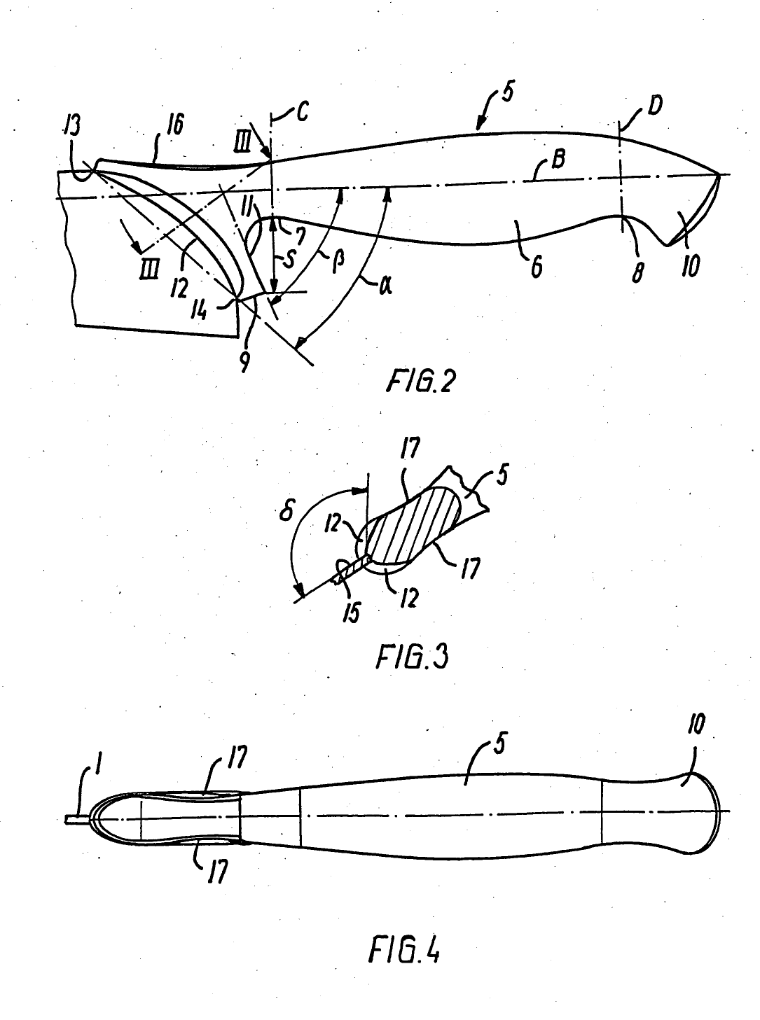

As more clearly shown in FIG. 2 the protrusion 9 has a rear face 11, which at the free end of the protrusion 9 extends under an acute angle β relative to the axis B. β is in the example in the range of 65-70°.

At the front (the point 2 of the knife being considered as the front end of the knife) the protrusion 9 constitutes a part of an end face 12 of the handle 5. The end face 12 extends between the end points 13 and 14. A line through the end points 13 and 14 extends under an acute angle γ relative to the axis B. γ is in the example in the range of 40-50°. As will be seen the end face 12 is concave and has in the example a radius of curvature in the range of 6-7 cm.

The end face 12 is in the embodiment divided into two equally big parts extending symmetrically on either side of the knife blade 1. The two parts of the end face 12 are beveled and form an obtuse angle δ with the side face 15 of the knife blade 1. δ is in the example in the range of 120-130°.

As will be seen in FIG. 2 the handle 5 is at the front at its upper side provided with a hollow 16. The hollow has a radius of curvature in the range of 13-15 cm.

As will be seen in FIGS. 3 and 4 the handle 5 is in front at its sides provided with a hollow 17. The radius of curvature of the hollow is in the range of 6-8 cm.

The handle shown in the figures and described herein makes it possible to use several different grips depending on the actual work to be done.

Thus, FIG. 5 shows a grip, in which the user grips the grip portion 6 of the handle 5 and rests the thumb in the hollow 16 to be able to press the cutting edge 3 downwards.

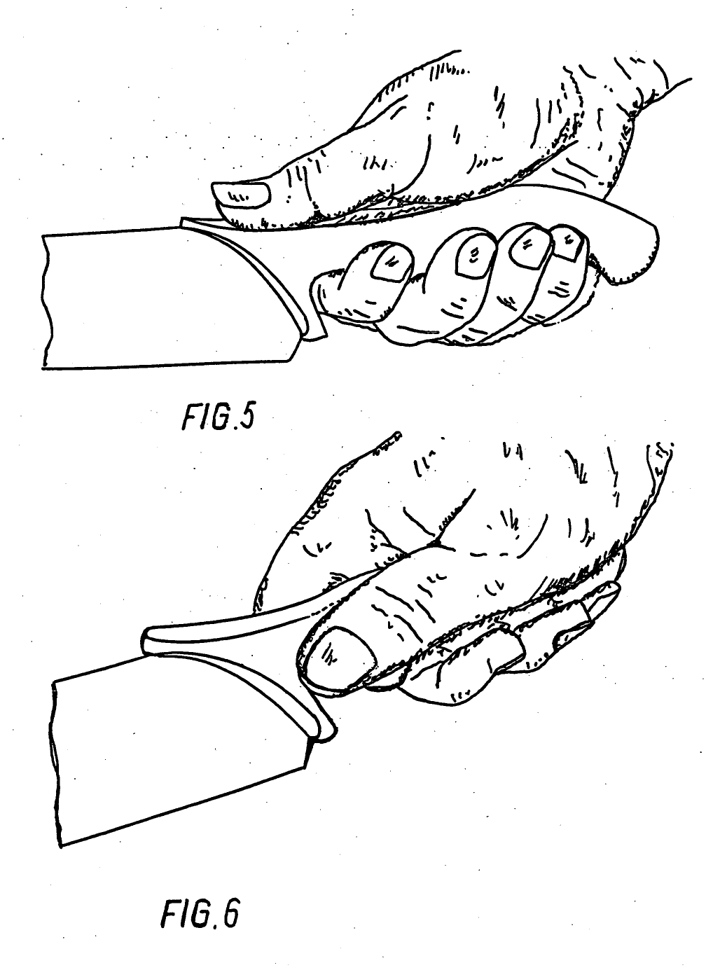

FIG. 6 shows a grip, in which the knife, compared to FIG. 5, is turned about the axis B relative to the hand of the user, whereby the thumb rests in one of the hollows 17.

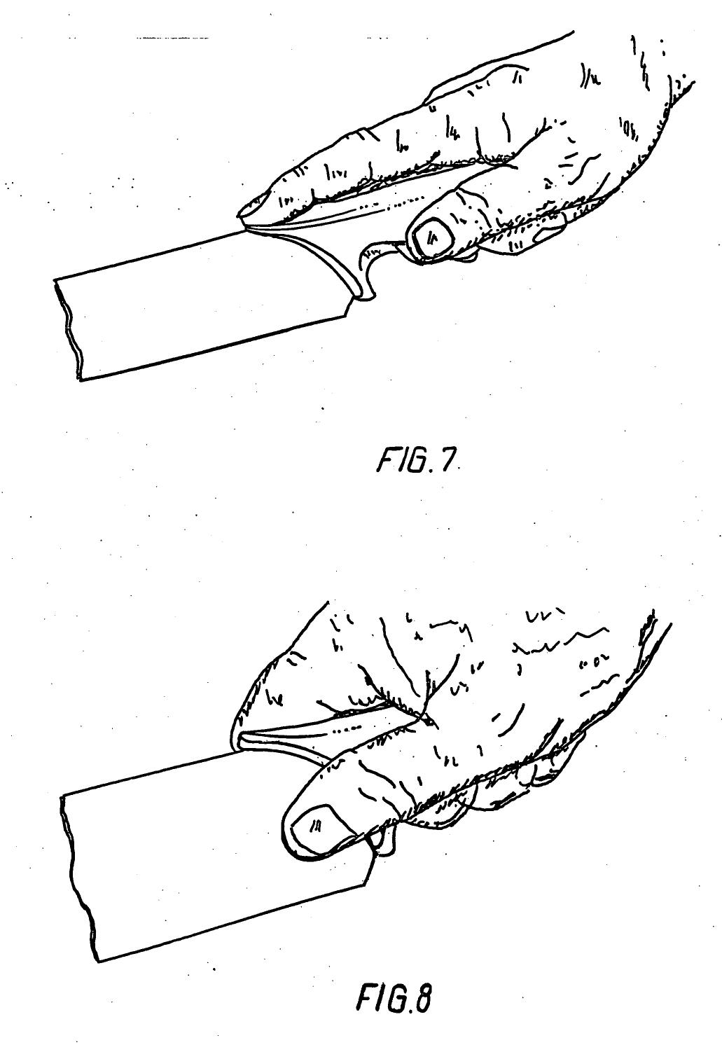

FIG. 7 shows the “precision grip,” in which the user lets his forefinger rest in the hollow 16 to be able to guide the knife more accurately.

Finally, FIG. 8 shows the “chopping grip,” in which the user has moved the hand forwards on the grip portion 6 as compared with the three previous grips. This grip is for instance very useful, when a chopping operation is to be performed. Due to the design of the handle according to the invention, the user has with this position of his hand a firm grip around the handle with the forefinger (hidden behind the knife blade) extending along the knife blade and the end face of the handle, the thumb resting against the end face of the handle and the knife blade on the other side thereof. At the same time the innermost joint of the forefinger may rest in the hollow 16.

The protrusion 9 extends a distance s, from the bottom of the indentation 7, which has such a size, for instance 20-25 mm, that the protrusion provides an effective stop for the forefinger, if the hand, for instance in case of the grip shown in FIG. 5, slips forward, in case the knife encounters resistance against a forward movement.

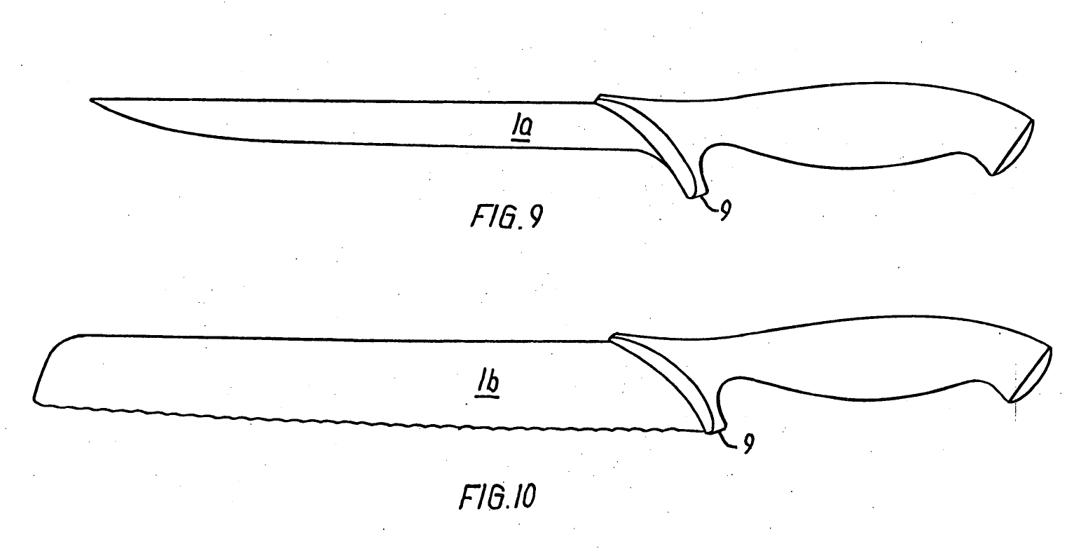

FIGS. 9 and 10 shows two knives having the same handle as the knife shown in the previous figures, but with different knife blades 1a and 1b. For the two latter knives the chopping grip may not be as relevant as for the former knife due to the fact that the knife blades 1a and 1b do not extend below the level of the protrusion 9. However the precision grip shown in FIG. 7 and the grips shown in FIGS. 5 and 6 are as relevant for the knives of FIGS. 9 and 10 as for the knife of FIGS. 1-8.

1. A knife with an ergonomic handle having a grip portion, said knife comprising an elongate knife blade with two side faces, a longitudinal lower cutting edge and an opposite longitudinal upper back extending from a free front end of the knife blade to the handle, the knife blade having an axis extending from a central point between the cutting edge and the back at the free front end to a central point between the cutting edge and the back at the handle, the handle extending along a second axis defined by central points of cross sections at intended resting points for the forefinger and the little finger of a user on the grip portion of the handle, wherein the two axes have directions with a mutual deviation of less than 20°, the handle having an end face extending between upper and lower end points along a side face of the knife blade at an end opposite its free front end, the lower end point being positioned on a protrusion of the handle in front of the grip portion, the protrusion having a rear face extending at a free end of the protrusion in a direction away from the gripping portion rearwards under a first acute angle relative to the second axis, said first acute angle being smaller than 80°, a line through said end points of the end face extending in a downward direction rearwards under a second acute angle relative to the second axis, said second acute angle being smaller than 50°.

2. A knife according to claim 1, wherein the first acute angle is smaller than 70°.

3. A knife according to claim 1, wherein the end face extends concavely between its end points.

4. A knife according to claim 3, wherein said end face extends concavely with a radius of curvature less than 20 cm.

5. A knife according to claim 4, wherein the radius of curvature is less than 10 cm.

6. A knife according to claim 5, wherein the radius of curvature is 6-7 cm.

7. A knife according to claim 1, wherein the distance between the end points is at least 45 mm.

8. A knife according to claim 7, wherein the said distance is at least 50 mm.

9. A knife according to claim 1, wherein the end face is beveled and forms an obtuse angle with the side face of the knife blade.

10. A knife according to claim 9, wherein said obtuse angle is smaller than 140° and bigger than 105°.

11. A knife according to claim 10, wherein said obtuse angle is smaller than 130° and bigger than 120°.

12. A knife according to claim 1, wherein the handle above the cutting edge has an upwards facing, concave face.

13. A knife with an ergonomic handle having a grip portion, said knife comprising an elongate knife blade with two side faces, a longitudinal lower cutting edge and an opposite longitudinal upper back extending from a free front end of the knife blade to the handle, the knife blade having an axis extending from a central point between the cutting edge and the back at the free front end to a central point between the cutting edge and the back at the handle, the handle extending along a second axis defined by central points of cross sections at intended resting points for the forefinger and the little finger of a user on the grip portion of the handle, wherein the two axes have directions with a mutual deviation of less than 10°, the handle having an end face extending between upper and lower end points along a side face of the knife blade at an end opposite its free front end, the lower end point being positioned on a protrusion of the handle in front of the grip portion, the protrusion having a rear face extending at a free end of the protrusion in a direction away from the gripping portion rearwards under a first acute angle relative to the second axis, said first acute angle being smaller than 80°, a line through said end points of the end face extending in a downward direction rearwards under a second acute angle relative to the second axis, said second acute angle being smaller than 50°.

14. A knife according to claim 13, wherein the first acute angle is smaller than 70°.

15. A knife according to claim 13, wherein said end face extends concavely with a radius of curvature less than 20 cm.

16. A knife according to claim 13, wherein the distance between the end points is at least 45 mm.

17. A knife according to claim 13, wherein the end face is beveled and forms an obtuse angle with the side face of the knife blade, said obtuse angle being smaller than 140° and bigger than 105°.

18. A knife according to claim 13, wherein the handle above the cutting edge has an upwards facing, concave face.
